(19) United States
(12) Patent Application Publication
(10) Pub. No.: US 2010/0002188 A1
(43) Pub. Date: Jan. 7, 2010

(54) BINOCULAR VIEWING DEVICE

(76) Inventor: Francois Merz, Neuchatel (CH)

Correspondence Address: FROMMER LAWRENCE & HAUG, 745 FIFTH AVENUE- 10TH FL., NEW YORK, NY, 10151, US

(21) Appl. No.: 12/447,599

(22) PCT Filed: Nov. 2, 2007
(86) PCT No.: PCT/IB07/03391

§ 371 Date: Apr. 28, 2009

(30) Foreign Application Priority Data
Nov. 16, 2006 (FR) 06/10034

(51) Int. Cl. G02C 7/02

(52) U.S. Cl. 351/158

(57) ABSTRACT

The present invention relates to a binocular viewing device (1). It is provided, for each eyepiece, with a first horizon line (4, 5) and with a second line (6, 7) perpendicular to the first. The intersection of the two lines lies approximately at the centre of the field of view (8, 9) of each eyepiece. The device is intended to make it easier to have a three-dimensional appreciation of the surrounding space, especially during the movement of the user or during the practice of certain sports by him.

The present invention relates to a binocular viewing device, each eyepiece being provided with perpendicular lines, designed to make it easier for its user to grasp the surrounding space three-dimensionally, especially when moving or practicing certain sports.

DE-A-32 02 000 proposes an optical grid formed of perpendicular bars of triangular cross section intended to correct certain optical aberrations.

JP-A-59 000 130 proposes glasses having a surface provided with a grid of lines creating a sort of veil at the surface of two lenses for purely esthetic reasons.

U.S. Pat. No. 4,309,085 proposes contact lenses provided with parallel horizontal or vertical lines or a grid or concentric circles enabling certain evolving characteristics of the eye to be measured.

It is known that learner drivers tend to focus on the obstacle to be avoided or moved around or overtaken instead of focusing on the objective to be attained, with the result of being attracted by the obstacle they are directed against. Likewise, the tightrope walker must not look at the ends of his feet or the space, but at the object to be reached, i.e. at the end of the rope. The skier who looks at the end of his skis will not be able to guide his skis and he will lose his balance or go straight on.

Even after learning, in the examples mentioned above, which are far from constituting an exhaustive list, there is a tendency in some situations to have a bad posture, for example, leaning the head into a bend while driving a vehicle, which has the effect of impeding movements.

Armed with these observations, the inventor has attempted to find a means enabling the correct use of binocular vision that allows the surrounding space to be apprehended three-dimensionally by adopting a correct posture.

The subject of the present invention, which is of surprising simplicity, helps its user to have this apprehension of the surrounding space permanently while focusing on the objective to be achieved.

The binocular viewing device according to the present invention is characterized in that each eyepiece is provided only with one first horizon line and one line perpendicular to the first, so that the point of intersection of these two single lines is marked by a visible point situated approximately at the center of the field of vision of each eyepiece.

The lines perpendicular (vertical) to the horizon line at the center of the view give the user the exact degrees of rotation of the head to be observed in relation to his speed of displacement. The horizon line (horizontal) represents the stable position. The adjustment is carried out by closing the left eye, the cross formed by the intersection of two lines must be located at the center of the view of the right eye and vice versa.

By using the device correctly, i.e. by looking while keeping the horizon line horizontal, correct posture of the person is obtained. The person apprehends space three-dimensionally and this enables him to anticipate correctly his various actions. Thus, for example, during training work on the ground, the horse rider has a view of the whole of the horse and in particular the four feet of the horse and not simply the front feet, or of all that resembles the locomotion of a quadruped-functions for which our brain has not been designed or which our brain has lost during our evolution. His commands and actions are carried out calmly without stress connected with the immediate action, which is, for example, properly clearing the obstacle in front of the horse. Both the rider and the horse act calmly, they hardly tire and attain the set aim. The scene is experienced in real time and the locomotive sequences are decomposed in relation to the actual reality of the development of the scene experienced in real time and not of an analysis just ahead of the result to be obtained, which often translates into movements that are exaggerated or even conditioned in view of the result. When driving a vehicle and entering a bend, leaning the body or the head distorts spatial vision and it is necessary to correct the direction or speed.

According to one embodiment, said lines have a thickness of about 0.25 mm.

According to a preferred embodiment, said device is a pair of glasses or a helmet visor or the windshield of a vehicle or a pair of contact lenses or frames without lenses.

According to one embodiment, said lines are marked by lines that are opaque, or translucent or in luminescent paint or the borders between two colors of a colored transparent material or the printing or engraving of said lines on said material. Luminescent paint is particularly useful for night vision or in the event of poor light.

According to another embodiment, said lines are marked by wires or light beams and means enabling their position to be adjusted. These means are not applicable to contact lenses.

According to one embodiment, the two lines perpendicular to the horizon lines extend to the edges of the binocular device.

According to another embodiment, the two lines perpendicular to the horizon lines may extend from the lower edge of the device and stop after their intersection with the horizon lines.

Alternatively, the two lines perpendicular to the horizon lines may extend from the upper edge of the device and stop after their intersection with the horizon lines.

If the binocular device is a pair of contact lenses, the lines may be inserted between two layers constituting the contact lenses.

The inventor has observed the effectiveness of this device by stretching wires over the outside face of a pair of glasses.

The invention will be described in greater detail with the help of the appended drawing.

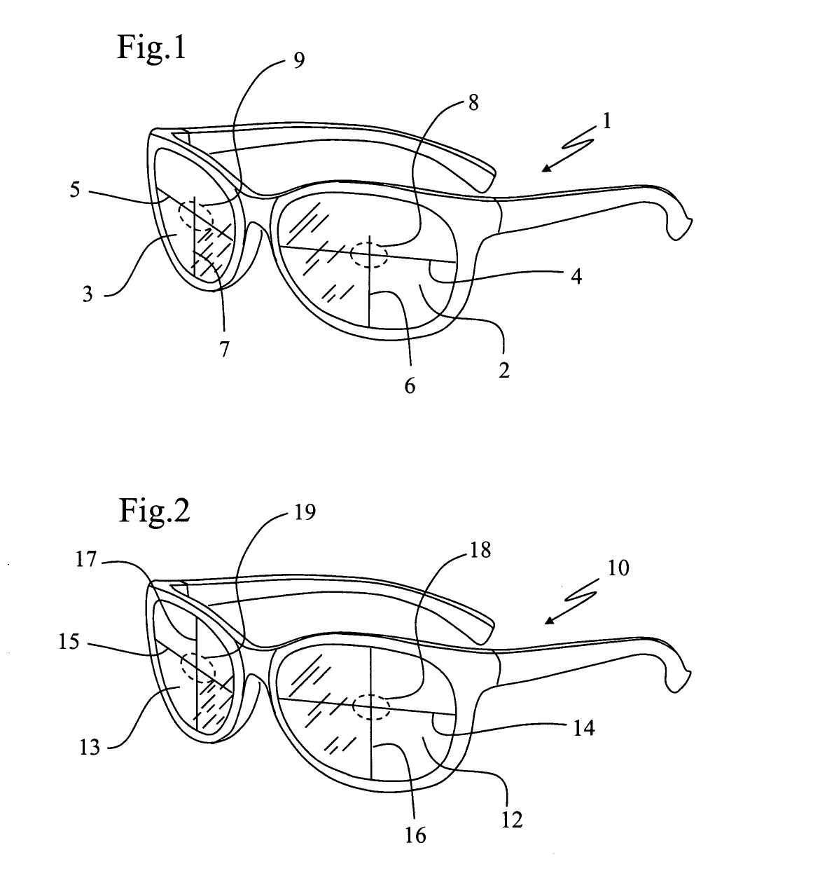

FIGS. 1 and 2 show, in perspective, two pairs of glasses according to two embodiments.

FIG. 1 shows a pair of glasses 1, the lenses 2 and 3 of which are provided with two horizon-line (horizontal) lines 4 and 5 and two lines 5 and 6 perpendicular (vertical) to the first ones. The points of intersection 21, 22 of the horizon lines with the perpendicular lines lie approximately at the centers of the fields of vision, are marked and visible, and are illustrated here with dotted lines 8 and 9. In order for these lines to be visible without impeding vision, they have a thickness of around 0.25 mm. They may be formed by printing or engraving or by using the difference in colors between the glass parts. They may also be fitted elements, for example, a wire or suchlike, with simple means of attachment enabling the wires to be put on or removed, or even their position in relation to the field of vision of the user to be adjusted. This is because the users do not wear the glasses in the same way, some position the glasses very close to the eyes and others further away.

The same can be applied to a visor of a helmet or the windshield of a vehicle. What is important is that, through their thickness and color, the lines do not disturb the vision of the user.

As previously explained, by keeping this horizon line horizontal the user with binocular vision achieves a three-dimensional analysis which translates into locomotive sequences decomposed in relation to the actual reality of the development of the scene experienced in real time and not in relation to the result to be obtained or movements conditioned in view of the result. The lines perpendicular (vertical) to the horizon lines at the center of the view give the user the exact degrees of rotation of the head to be observed in relation to his speed of displacement. The horizon line (horizontal) represents the stable position. The reading of the hatched part by our brain marks a corridor. The corridor represents the obligatory passing of a bend, for example. Adjustment is carried out by closing the left eye, the cross formed by the intersection of two lines must be located at the center of the view of the right eye and vice versa.

The difference between the device of FIG. 1 and that of FIG. 2 is the fact that the perpendicular lines 18 and 19 extend from the lower edge to the upper edge of the pair of glasses 10, while in FIG. 1 the lines 8 and 9 pass beyond the points of intersection 23, 24 with the horizon lines 4 and 5 by about 1 cm. Apart from this difference, the elements referred to as 10-15 and 18, 19 of FIG. 2 correspond to the elements described as 1-5 and 8, 9 of FIG. 1.

In some applications, and in particular practicing golf, it turns out that the lines perpendicular to the horizon lines must start at the upper edge and stop after the points of intersection.

Contact lenses may also be used provided with these lines, but not with wires or light beams.

With regard to light beams, it is possible to use two diodes (LEDs) the beams from which cross in the field of vision. The power supply for these diodes may be provided by a battery. If it is desired to be able to adjust the point of intersection of two light beams for matching it to the field of vision of the user, the diodes may, for example, be mounted on a slide which enables them to be moved.

In the case of lenses mounted in a frame or contact lenses, these may be lenses without any correction of vision or with medically prescribed correction of vision, tinted or not tinted.

A frame without lenses may be used, worn directly by the user or to be attached onto the frame usually worn by the user for protection from the sun or for correction of sight.

The frames and the optional lenses may be made of any conventionally used material.

A night vision system may also be provided with the device according to the invention by providing the eyepieces with lines according to the invention directly on the lenses or via an adapted frame.

1. A binocular viewing device, each eyepiece being provided with perpendicular lines, wherein each eyepiece is provided only with one first horizon line and one line perpendicular to the first, so that the point of intersection of these two single lines is marked by a visible point situated approximately at the center of the field of vision of each eyepiece.

2. The device as claimed in claim 1, wherein said lines have a thickness of about 0.25 mm.

3. The device as claimed in claim 1, wherein said device is a pair of glasses or a helmet visor or the windshield of a vehicle or a pair of contact lenses or frames without lenses.

4. The device as claimed in claim 1, wherein said lines are marked by lines that are opaque, or translucent or in luminescent paint or the borders between two colors of a colored transparent material or the printing or engraving of said lines on said material.

5. The device as claimed in claim 1, wherein said lines are marked by wires or light beams and means enabling their position in relation to the field of view to be adjusted, with the exception of contact lenses.

6. The device as claimed in claim 1, wherein the two lines perpendicular to the horizon lines extend to the edges of the binocular device.

7. The device as claimed in claim 1, wherein the two lines perpendicular to the horizon lines extend from the lower edge of the device and stop after their intersection with the horizon lines.

8. The device as claimed in claim 1, wherein the line perpendicular to the horizon line extends from the upper edge of the device and stops after its intersection with the horizon line.

9. The device as claimed in claim 1, wherein the device comprises two contact lenses and in that said lines are inserted between two layers constituting the contact lenses.
